(19) United States
(12) Patent Application Publication
(10) Pub. No.: US 2024/0169827 A1
(43) Pub. Date: May 23, 2024

(54) TRAFFIC MONITORING APPARATUS, TRAFFIC MONITORING SYSTEM, TRAFFIC MONITORING METHOD, AND NON-TRANSITORY STORAGE MEDIUM

(71) Applicant: NEC Corporation, Minato-ku, Tokyo (JP)

(72) Inventors: Masatake Takahashi, Tokyo (JP); Hitoshi Sakurai, Tokyo (JP)

(73) Assignee: NEC Corporation, Minato-ku, Tokyo (JP)

(21) Appl. No.: 18/279,333

(22) PCT Filed: Feb. 16, 2022
(86) PCT No.: PCT/JP2022/006216

§ 371 Date: Aug. 29, 2023

(30) Foreign Application Priority Data
Mar. 4, 2021 (JP) 2021-034187

(51) Int. Cl. G08G 1/01; G08G 1/04

(52) U.S. Cl. CPC G08G 1/0133; G08G 1/04

(57) ABSTRACT

A traffic monitoring apparatus (103) includes a front position detection unit (112) that detects a front position of congestion on a road R, and an output unit (114) that outputs, when movement of the detected front position satisfies a previously determined criterion, congestion information according to the criterion. The front position detection unit (112) acquires a vehicle position on the road R acquired based on optical fiber sensing utilizing an optical fiber laid on the road R.

### TECHNICAL FIELD

The present invention relates to a traffic monitoring apparatus, a traffic monitoring system, a traffic monitoring method, and a program.

### Background Art

In PTL 1, a technique described in PTL 1 performs reverse driving vehicle detection processing when deciding that no traffic congestion has occurred.

### CITATION LIST

### Patent Literature

PTL 1: Japanese Patent Application Publication No. 2007-72796

### SUMMARY OF INVENTION

### Technical Problem

However, when a reverse driving vehicle travels on a road, a vehicle traveling on a road R in an original traveling direction often decelerates for safety. Thus, congestion may occur owing to the reverse driving vehicle. With a technique described in PTL 1, it is difficult to recognize congestion due to a reverse driving vehicle. Thus, it is difficult to accurately recognize a traffic situation of a road.

The present invention has been made in view of the problem described above, and is intended to provide a traffic monitoring apparatus, a traffic monitoring system, a traffic monitoring method, and a program that are capable of accurately recognizing a traffic situation of a road.

### Solution to Problem

In order to achieve the object described above, a traffic monitoring apparatus according to a first aspect of the present invention includes:
a front position detection means for detecting a front position of congestion on a road; and
an output means for outputting, when movement of the detected front position satisfies a previously determined criterion, congestion information according to the criterion.

A traffic monitoring system according to a second aspect of the present invention includes:
the above traffic monitoring apparatus;
an optical fiber being laid on the road and having one end subjected to termination processing that suppresses reflection of an optical signal; and
a sensing apparatus that inputs an optical signal to the optical fiber, and also observes a change amount of optical interference intensity being intensity of light in which beams of backscattered light generated due to the input of the optical signal interfere with each other, wherein
the front position detection means acquires a vehicle position on the road acquired based on the change amount of the optical interference intensity observed by the sensing apparatus, and detects a front position of congestion on the road, based on the vehicle position.

A traffic monitoring method according to a third aspect of the present invention includes by a computer:
detecting a front position of congestion on a road; and
performing, when movement of the detected front position satisfies a previously determined criterion, output according to the criterion.

A program according to a fourth aspect of the present invention is a program for causing a computer to function as the traffic monitoring apparatus described above.

### Advantageous Effects of Invention

According to the present invention, it becomes possible to recognize a traffic situation over a wide area in real time in an overlooking way.

### BRIEF DESCRIPTION OF DRAWINGS

FIG. 1 is a diagram illustrating a configuration of a traffic monitoring system and a first example of history information according to one example embodiment of the present invention.

FIG. 2 is an example of history information illustrating the first example of the history information illustrated in FIG. 1 in a range of a position and a time being wider than that in FIG. 1.

FIG. 3 is a diagram illustrating a second example of history information according to one example embodiment.

FIG. 4 is an example of history information illustrating the second example of the history information illustrated in FIG. 3 in a range of a position and a time being wider than that in FIG. 3.

FIG. 5 is a diagram illustrating a functional configuration of a traffic monitoring apparatus according to one example embodiment of the present invention.

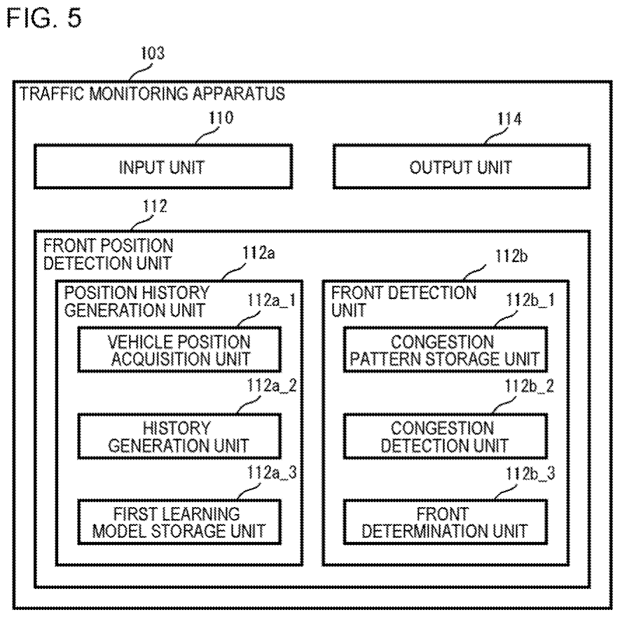

FIG. 6 is a diagram illustrating one example of congestion pattern information according to one example embodiment.

FIG. 7 is a diagram illustrating a functional configuration of an output unit according to one example embodiment.

FIG. 8 is a diagram illustrating one example of criterion information according to one example embodiment.

FIG. 9 is a diagram illustrating one example of a physical configuration of the traffic monitoring apparatus according to one example embodiment of the present invention.

FIG. 10 is a flowchart illustrating one example of traffic monitoring processing according to one example embodiment of the present invention.

FIG. 11 is a flowchart illustrating one example of a front position detection processing step S101 illustrated in FIG. 10.

FIG. 12 is a flowchart illustrating one example of an output processing step S102 illustrated in FIG. 10.

### DESCRIPTION OF EMBODIMENTS

Hereinafter, one example embodiment of the present invention is described with reference to the drawings. Through all figures, the same element is assigned with the same reference sign. Note that, in all of the drawings, a similar component is assigned with a similar reference sign, and description thereof is omitted as appropriate.

<Configuration of Traffic Monitoring System According to One Example Embodiment>

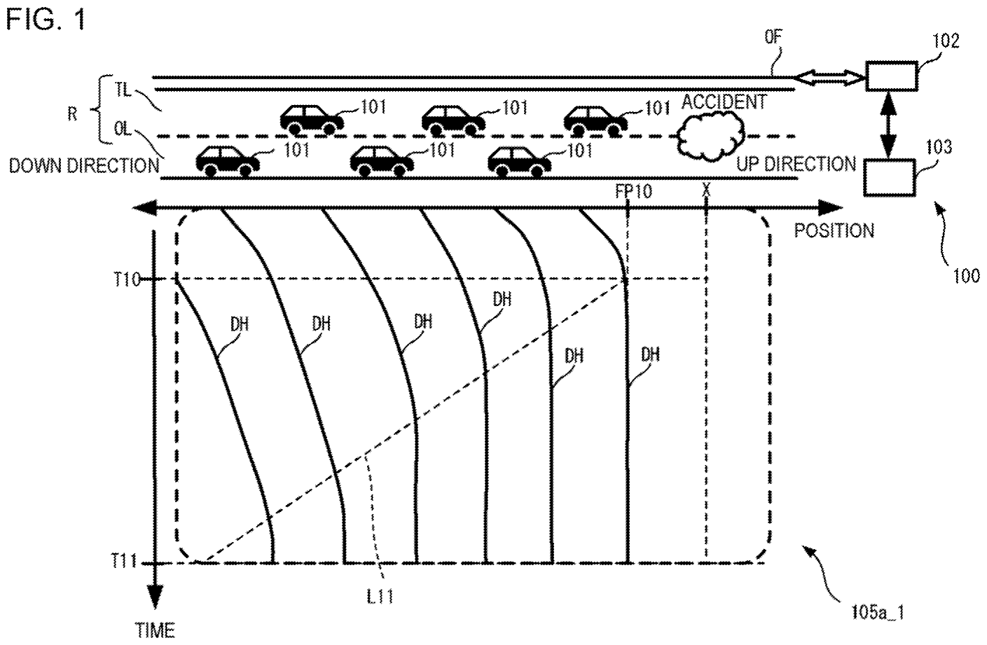

As illustrated in FIG. 1, a traffic monitoring system 100 according to one example embodiment of the present invention is a system for monitoring traffic of a vehicle 101 traveling on a road R, by utilizing an optical fiber sensing technique. The road R illustrated in FIG. 1 is a road for going in an up-direction, and includes a traveling lane TL and an overtaking lane OL. Moreover, the vehicle 101 is an automobile, a two-wheeled vehicle, a bus, a truck, or the like.

Note that, the road R is typically an expressway, but may be another general road. Moreover, the number of lanes included in the road R is not limited to two, and may be one or more.

The traffic monitoring system 100 includes an optical fiber OF, a sensing apparatus 102, and a traffic monitoring apparatus 103.

The optical fiber OF is an optical fiber cable laid on the road R. The optical fiber OF is, for example, one core of a multi-core optical fiber cable for communication generally laid on a road shoulder, a median strip, or the like of an expressway, has one end to which the sensing apparatus 102 is connected, and has another end subjected to termination processing that suppresses reflection of an optical signal. Note that, a plurality of fiber cables of the multi-core optical fiber cable may be adopted as the optical fiber OF for optical fiber sensing.

The sensing apparatus 102 inputs an optical signal to the optical fiber OF, and also observes a change amount of optical interference intensity being intensity of light in which beams of backscattered light generated due to the input of the optical signal interfere with each other.

Specifically, for example, the sensing apparatus 102 inputs an optical signal having a pulse waveform from one end of the optical fiber OF. Thereby, weak return light to be called backscattered light is generated from all positions of the optical fiber OF. The sensing apparatus 102 observes the backscattered light.

When an environmental change occurs around the optical fiber OF, structure and a feature parameter of silica glass forming the optical fiber change with the environmental change, and a signal quality of backscattered light from a location where the change occurs also changes.

When an optical signal with a high coherence property is input, and vibration during passage of the vehicle 101 on the road R is transmitted to the optical fiber OF, a phase state of backscattered light changes. The change in the phase state of the backscattered light is observed as a change in light intensity due to interference with another backscattered light received at the same time. That is to say, the sensing apparatus 102 inputs an optical signal to the optical fiber OF, and observes a change amount of optical interference intensity generated by vibration application.

An occurrence location of vibration can be derived based on a change amount of optical interference intensity, and is computed from a round-trip time from input of an optical signal to observation of backscattered light, and a propagation velocity of the optical signal. An optical signal is repeatedly input at a constant frequency in such a way that backscattered light from the another end of the optical fiber OF (i.e., the farthest end when viewed from the sensing apparatus 102) does not mix with an optical signal input next. Thereby, transition of an environmental change in vibration or the like occurring around the optical fiber OF can be accurately observed in real time.

In this way, optical fiber sensing is a technique that detects an occurrence location of vibration or the like, with an optical fiber OF as a sensing medium. In the technique, a general optical fiber OF being a transmission medium of communication data can be utilized as a linear passive sensor, and, therefore, a traffic situation over a wide area can be recognized in real time in an overlooking way, without installing a new sensor or the like.

The traffic monitoring apparatus 103 repeatedly acquires, from the sensing apparatus 102, observation information including an occurrence location of vibration on the road R. The occurrence location of vibration is associated with a position of the vehicle 101 (vehicle position) on the road R. Thus, the observation information includes position information indicating the vehicle position.

The traffic monitoring apparatus 103 derives a history (i.e., a change over time in a vehicle position) DH of a vehicle position, based on the position information repeatedly acquired from the sensing apparatus 102. Then, the traffic monitoring apparatus 103 detects, based on the history DH of the vehicle position, congestion that has occurred on the road R. The traffic monitoring apparatus 103 further outputs, to a previously determined apparatus, congestion information including occurrence of congestion and a cause thereof, based on movement of a front position of the detected congestion. A cause of congestion according to the present example embodiment is a reverse driving vehicle, a low-velocity vehicle, or the like (e.g., an accident).

FIG. 1 additionally illustrates a first example of history information 105a_1 according to the present example embodiment. The history information 105a_1 indicates the history DH of a vehicle position of each of the vehicles 101 traveling on the road R when an accident occurs at a position X at a time T10.

As illustrated in the figure, the history information 105a_1 is represented by a relationship between a vehicle position on the road R and time. In FIG. 1, a solid line in the figure in which a horizontal axis indicates a position on the road R and a vertical axis indicates time represents the history DH of a vehicle position of each of the vehicles 101 traveling on the road R.

Specifically, the history information 105a_1 indicates a change over time in a vehicle position of each of the vehicles 101 in which the vehicle 101 traveling downstream of an accident occurrence location X1 at the occurrence time T10 of an accident sequentially performs low-velocity traveling before stopping. For example, the vehicle traveling at a front at the accident occurrence time T10 starts low-velocity traveling from the time T10, and stops at a position FP10.

“Low-velocity traveling” is traveling at a velocity equal to or less than a previously determined velocity (e.g., 40 km per hour).

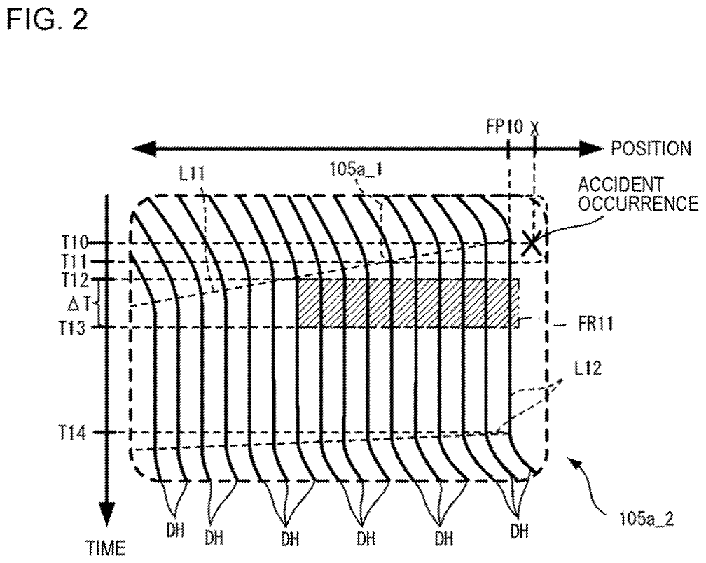

FIG. 2 is an example of history information 105a_2 indicating the first example of the history information 105a_1 illustrated in FIG. 1 in a range of a position and a time being wider than that in FIG. 1.

Herein, a dotted line L11 illustrated in FIGS. 1 and 2 is an example of a low-velocity traveling start line when an accident occurs.

The low-velocity traveling start line is an approximate line that connects a low-velocity traveling start point regarding each of the vehicles 101 traveling on the road R. Moreover, the low-velocity traveling start point is a point determined by a time when the vehicle 101 starts low-velocity traveling and the vehicle position at the time in a figure including the history DH.

A dotted frame FR11 illustrated in FIG. 2 is a frame indicating a region being associated with definition of congestion.

Congestion may be defined as appropriate, but is defined, for example, as a state where, as to a vehicle being equal to or less than a criterion velocity (e.g., a velocity of equal to or less than 40 km per hour), there are vehicles being equal to or more than a predetermined number within a predetermined time ΔT and within a predetermined distance ΔD, or the like. A case where a predetermined number is 10 is described below as an example.

In light of the definition, the predetermined time ΔT is associated with a length in a vertical direction of the frame FR11. The predetermined distance ΔD is associated with a length of the frame FR11 in a horizontal direction. Congestion occurs when the number of the histories DH indicating traveling being equal to or less than a criterion velocity or stopping is equal to or more than 10 (a number according to a predetermined number) within a region of the frame FR11. Herein, the history DH within a region of the frame FR11 is the history DH from an upper side to a lower side.

It is assumed that a time difference between a time T12 and a time T13 is a predetermined time ΔT. At the time T13, the number of the histories DH indicating traveling at equal to or less than a criterion velocity or stopping from the upper side to the lower side of the region of the frame FR11 becomes 10 initially after the time T10. That is to say, the time T13 is a time when congestion is detected initially after the time T10.

A time T14 is a time when restoration work of the accident has ended. Thus, at and after the time T14, traveling is started from the vehicle 101 at a front in order.

A dotted line L12 is an example of a congestion front line in accident congestion. The congestion front line is an approximation line that connects a position of a front of congestion.

As indicated by a dotted line L12, the congestion front line in accident congestion is constant at the position FP10 among times T10 to T14. Then, at and after time T14, movement is made in a direction being opposite to the traveling direction.

In this way, in general congestion such as accident congestion, a front position of congestion hardly moves for equal to or more than a certain time. That is to say, in general congestion, a front position of congestion is within a previously determined range for equal to or more than a previously determined time TTH from detection of congestion.

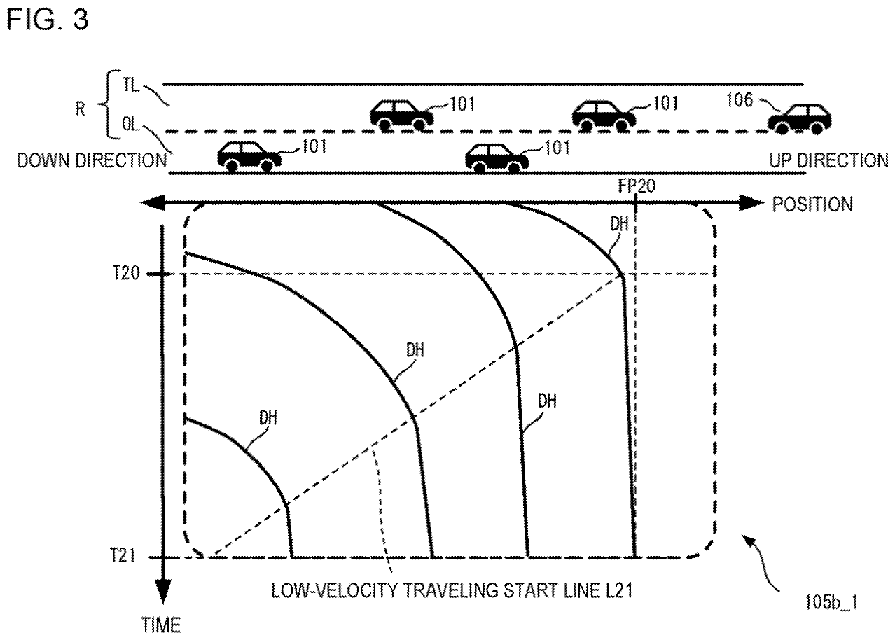

Next, FIG. 3 illustrates a second example of history information 105b_l according to the present example embodiment. The history information 105b_1 indicates the history DH of a vehicle position of each of the vehicles 101 traveling on the road R when a reverse driving vehicle 106 travels on the road R. The reverse driving vehicle 106 is a vehicle that drives reverse on the road R.

In FIG. 3 as well, similarly to the history information 105b_1 illustrated in FIG. 1, a solid line in the figure in which a horizontal axis indicates a position on the road R and a vertical axis indicates time represents the history DH of a vehicle position of each of the vehicles 101 traveling on the road R.

Specifically, the history information 105b_l indicates a change over time in a vehicle position of each of the vehicles 101 in which the vehicle 101 traveling downstream of the reverse driving vehicle 106 rapidly decelerates into low-velocity traveling sequentially, and then travels at an extremely slow velocity. For example, it is indicated that a vehicle at a front that has found the reverse driving vehicle 106 rapidly decelerates into low-velocity traveling at a time T20, then travels at an extremely slow velocity, and is at a position FP2 at a time T21.

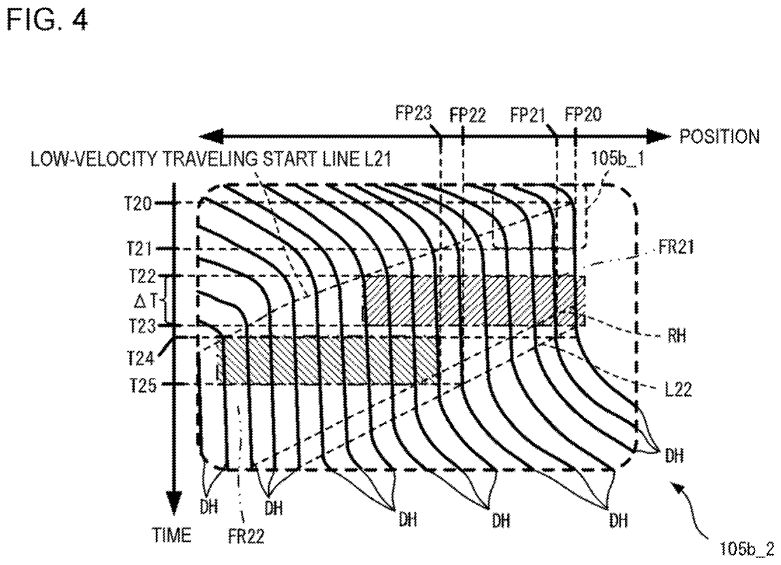

FIG. 4 is an example of history information 105b_2 illustrating the first example of the history information 105b_1 illustrated in FIG. 3, in a range of a position and a time being wider than that in FIG. 3.

Herein, a dotted line L21 illustrated in FIGS. 3 and 4 is an example of a low-velocity traveling start line when the reverse driving vehicle 106 travels.

A dotted line RH is a traveling history of the reverse driving vehicle 106.

It is assumed that a time difference between a time T22 and a time T23 is a predetermined time ΔT. At the time T23, the number of the histories DH indicating traveling at equal to or less than a criterion velocity from an upper side to a lower side of a region of a frame FR21 becomes 10 initially after the time T20. That is to say, the time T23 is a time when congestion is detected initially after the time T20.

A time T24 is a time when a vehicle at a front traveling in the traveling direction of the road R accelerates after passing the reverse driving vehicle 106, and turns to high-velocity traveling. The high-velocity traveling is traveling at a faster velocity than the low-velocity traveling.

A dotted line L22 is an example of a congestion front line when the reverse driving vehicle 106 travels.

As indicated by the dotted line L22, a congestion front position at the time T23 is a position FP20. At the time T24, since the vehicle 101 that has been at a front up to then turns to high-velocity traveling and exits congestion, a front position of the congestion becomes a position FP21.

At a time T25, the vehicle 101 that has been at a front up to then turns to high-velocity traveling a position FP22 and exits congestion. As can be understood by referring to the FR22, the congestion continues, and a front position thereof becomes a position FP23.

In this way, in congestion resulting from the reverse driving vehicle 106, a front position of the congestion seldom stays at a constant position, and moves at a certain speed in a direction opposite to the traveling direction of the road R. That is to say, in congestion resulting from a reverse driving vehicle, a front position of the congestion moves in a direction opposite to the traveling direction of the road R within a time shorter than the previously determined time TTH after the congestion is detected. A moving velocity of the front position of the congestion in this case is faster than a previously determined first threshold value.

Herein, a pattern of the history DH of a vehicle position being associated with congestion resulting from an accident and congestion resulting from the reverse driving vehicle 106 has been described with reference to FIGS. 1 to 4. In addition thereto, congestion may also occur due to, for example, a low-velocity vehicle. A low-velocity vehicle is a vehicle being slower than an appropriately determined velocity, such as a cleaning vehicle of a road, or the general vehicle 101.

In a case of congestion resulting from a low-velocity vehicle, a front position of the congestion moves in the traveling direction of the road R within a time shorter than the previously determined time TTH after the congestion is detected. A moving velocity of the front position of the congestion in this case is slower than a previously determined second threshold value.

<Functional Configuration of the Traffic Monitoring Apparatus 103>

The traffic monitoring apparatus 103 according to the present example embodiment includes an input unit 110, a front position detection unit 112, and an output unit 114.

The input unit 110 is a keyboard, a mouse, a touch panel, or the like for a user to input an instruction or the like.

The front position detection unit 112 acquires a vehicle position on the road R from the sensing apparatus 102, and detects, based on the vehicle position, a front position of congestion on the road R.

The front position detection unit 112 includes a position history generation unit 112a and a front detection unit 112b.

The position history generation unit 112a acquires a vehicle position on the road R, and generates, based on the vehicle position, history information 105 indicating the history DH of a vehicle position of the vehicle 101 on the road R. Herein, the history information 105 is a general term for pieces of the history information 105a_1, 105a_2, 105b_1, and 105b_2 described above. Moreover, the front detection unit 112b detects, based on the history DH of the vehicle position, a front position of congestion occurring on the road R.

Specifically, the position history generation unit 112a includes a vehicle position acquisition unit 112a_1, a history generation unit 112a_2, and a first learning model storage unit 112a_3.

The vehicle position acquisition unit 112a_1 acquires, from the sensing apparatus 102, position information on the road R acquired based on optical fiber sensing utilizing the optical fiber OF laid on the road R.

More specifically, the vehicle position acquisition unit 112a_1 repeatedly acquires, from the sensing apparatus 102, position information on the road R acquired based on a change amount of optical interference intensity observed by the sensing apparatus 102.

Note that, the present example embodiment is described with an example in which position information is acquired based on optical fiber sensing, but position information may be acquired based on information acquired from various sensors to be set on the road R, such as a CCTV camera, or a traffic meter (coil). Further, position information may be acquired based on probe information of electronic toll collection system (ETC) 2.0 or the like.

The history generation unit 112a_2 generates, based on position information acquired by the vehicle position acquisition unit 112a_1, the history information 105 indicating a change over time in a vehicle position on the road R from past to present.

Specifically, as described above, position information is included in the observation information acquired based on an optical signal input at a constant frequency. Thus, the position information repeatedly acquired by the position acquiring unit 106 indicates a relatively short time interval but a discrete vehicle position.

The history generation unit 112a_2 generates, with the discrete vehicle position as an input, the history information 105 according to a first learning model. The history information 105 continuously indicates a change over time in a vehicle position, as indicated by the line DH in FIGS. 1 to 4.

Note that, the history generation unit 112a_2 may acquire an approximated curve or an approximated straight line of a discrete vehicle position, or a combination thereof, and thereby generate history information indicating the acquired approximated curve or approximated straight line, or the acquired combination thereof.

The first learning model storage unit 112a_3 is a storage unit for previously storing the first learning model referred to by the history generation unit 112a2.

The first learning model is a learned learning model that has performed machine-learning for generating the history information 105 with, as an input, the position information included in the observation information from the sensing apparatus 102. Supervised learning may be adopted for learning of the first learning model. Training data in this case may be generated based on probe information of the vehicle 101 that has actually traveled, an in-vehicle camera, and the like.

Moreover, the front detection unit 112b detects a front position of congestion on the road R, based on the history information 105 generated by the position history generation unit 112a.

Specifically, the front detection unit 112b includes a congestion pattern storage unit 112b_1, a congestion detection unit 112b_2, and a front determination unit 112b_3.

The congestion pattern storage unit 112b_1 is a storage unit that stores congestion pattern information 121 indicating a congestion pattern. The congestion pattern is a pattern of the history DH of a vehicle position on the road R when congestion occurs. The congestion pattern is determined according to definition adopted by the traffic monitoring apparatus 103.

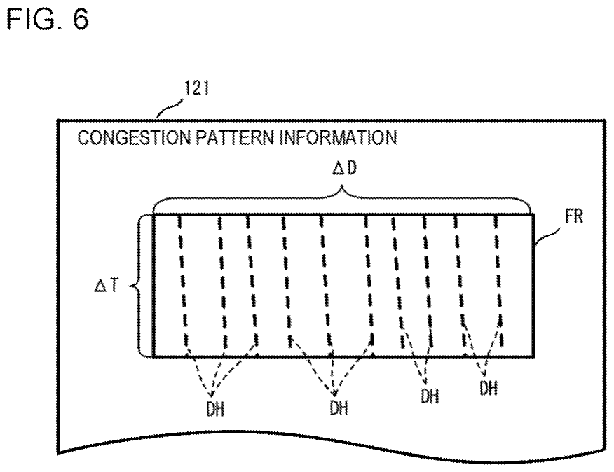

FIG. 6 illustrates one example of the congestion pattern information 121 according to the present example embodiment.

In the present example embodiment, as described above, it is assumed that congestion is a state where, as to a vehicle being equal to or less than a criterion velocity, there are vehicles equal to or more than a predetermined number within the predetermined time ΔT and within the predetermined distance ΔD. Moreover, it is assumed that the predetermined number is 10. Herein, a vehicle being equal to or less than a criterion velocity includes a vehicle that has stopped, and includes, for example, a vehicle that repeats such stopping and starting that an average velocity becomes equal to or less than the criterion velocity.

The congestion pattern information 121 illustrated in FIG. 6 is an example including a congestion pattern according to the definition. In the congestion pattern, a length of a frame FR in a vertical direction is the predetermined time ΔT, and a length of the frame FR in a horizontal direction is the predetermined distance ΔD. Then, within the frame FR, the number of the histories DH of a vehicle position indicating equal to or less than the criterion velocity is equal to or more than 10. The frames FR11, FR21, and FR22 described above are examples in which the frame FR included in the congestion pattern information 121 illustrated in FIG. 6 is applied.

The velocity (e.g., Km/Hour) of the vehicle 101 is a value acquired by dividing a moving distance by a time required for moving the moving distance, and therefore appears in a slope of the history DH of a vehicle position. Moreover, a fact that the history DH of a vehicle position is within the frame FR means that each of an upper end and a lower end of the history DH of the vehicle position intersects not each of left and right sides of the frame FR but an upper side and a lower side thereof.

The congestion detection unit 112b_2 detects congestion on the road R, based on the history DH of the vehicle position indicated by the history information 105 generated by the position history generation unit 112a, and the congestion pattern indicated by the congestion pattern information 121. The congestion detection unit 11211_2 detects congestion on the road R, for example, by collating (e.g., pattern matching) the history DH of the vehicle position with the congestion pattern.

The front determination unit 112b_3 determines, when the congestion detection unit 112b_2 detects congestion, a front position of the congestion.

Specifically, for example, as to congestion, congestion is detected when the history DH of a vehicle position up to present is collated (e.g., pattern matching) with a congestion pattern, and, as a result of the collation, the history DH and the congestion pattern match to a previously determined degree.

A front position of congestion in this case is determined as a vehicle position of the vehicle 101 positioned most forward (a right side in the history DH in FIGS. 1 to 4) in the traveling direction, in a region matching the congestion pattern in the history DH.

FIG. 3 is referred to again.

When movement of a front position of congestion detected by the front position detection unit 112 satisfies a previously determined criterion, the output unit 114 outputs congestion information according to the criterion.

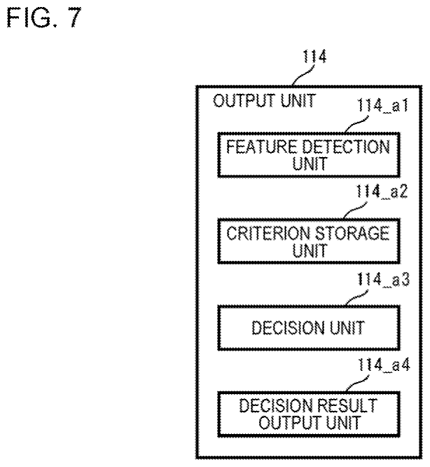

Specifically, as illustrated in FIG. 7, the output unit 114 includes a feature detection unit 114_a1, a criterion storage unit 114_a2, a decision unit 114_a3, and a decision result output unit 114_a4.

The feature detection unit 114_a1 detects a feature of movement of a front position of congestion, based on the history DH of a vehicle position where the front position detection unit 112 has detected congestion. The feature of the movement includes a moving direction and a velocity of the movement.

The criterion storage unit 114_a2 is a storage unit that stores criterion information 124 for estimating a cause of congestion. The criterion information 124 includes one or a plurality of criteria previously determined in relation to movement of a front position of congestion.

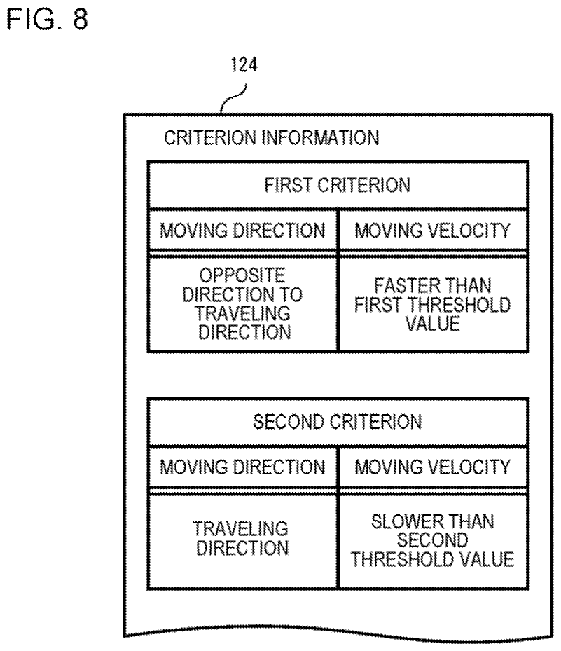

FIG. 8 illustrates one example of the criterion information 124 according to the present example embodiment. As illustrated in the figure, the criterion information 124 includes a first criterion and a second criterion. Note that, the criterion information 124 may include at least one criterion for estimating a cause of congestion.

The first criterion is a criterion for estimating congestion resulting from the reverse driving vehicle 106, a moving direction includes being an opposite direction to the traveling direction of the road R, and a moving velocity includes being faster than a previously determined first threshold value.

The second criterion is a criterion for estimating congestion resulting from a low-velocity vehicle, a moving direction includes being the traveling direction of the road R, and a moving velocity includes being slower than a previously determined second threshold value.

The decision unit 114_a3 decides a cause of congestion, based on a feature of movement at a front position detected by the feature detection unit 114_a1, and the criterion information 124 stored in the criterion storage unit 114_a2.

Specifically, for example, the decision unit 114_0 decides that a cause of congestion is the reverse driving vehicle 106 when a feature of movement satisfies the first criterion. The decision unit 114_a3 decides that a cause of congestion is a low-velocity vehicle when the feature of the movement satisfies the second criterion. The decision unit 1140 decides that a cause of congestion is unknown when the feature of the movement does not satisfy the first criterion and the second criterion.

The decision result output unit 114_a4 outputs congestion information according to a decision result of the decision unit 114_0.

Specifically, for example, when the decision unit 114_0 decides that a cause of congestion is the reverse driving vehicle 106, the decision result output unit 114_a4 outputs first congestion information. The first congestion information is information indicating that congestion caused by the reverse driving vehicle 106 has occurred.

Moreover, for example, when the decision unit 114_a3 decides that a cause of congestion is a low-velocity vehicle, the decision result output unit 114_a4 outputs second congestion information. The second congestion information is information indicating that congestion caused by a low-velocity vehicle has occurred.

Further, for example, when the decision unit 114_a3 decides that a cause of congestion is unknown, the decision result output unit 114_a4 outputs third congestion information. The third congestion information is information indicating that congestion of an unknown cause has occurred.

Note that, when the congestion detection unit 112b_2 does not detect congestion, the decision result output unit 114_a4 may output congestion information indicating that no congestion has occurred.

An output destination of congestion information from the decision result output unit 114_a4 may be a display unit included in the traffic monitoring apparatus 103, may be a driving control apparatus mounted on the vehicle 101, or may be an information processing apparatus such as a previously determined server. When output to the driving control apparatus, the congestion information may be displayed on a display unit of the vehicle 101, and may be utilized for autonomous driving of the vehicle 101, and communication between the vehicles 101 traveling on the road R.

<Physical Configuration of the Traffic Monitoring Apparatus 103>

From now on, an example of a physical configuration of the traffic monitoring apparatus 103 according to the present example embodiment is described with reference to the drawings.

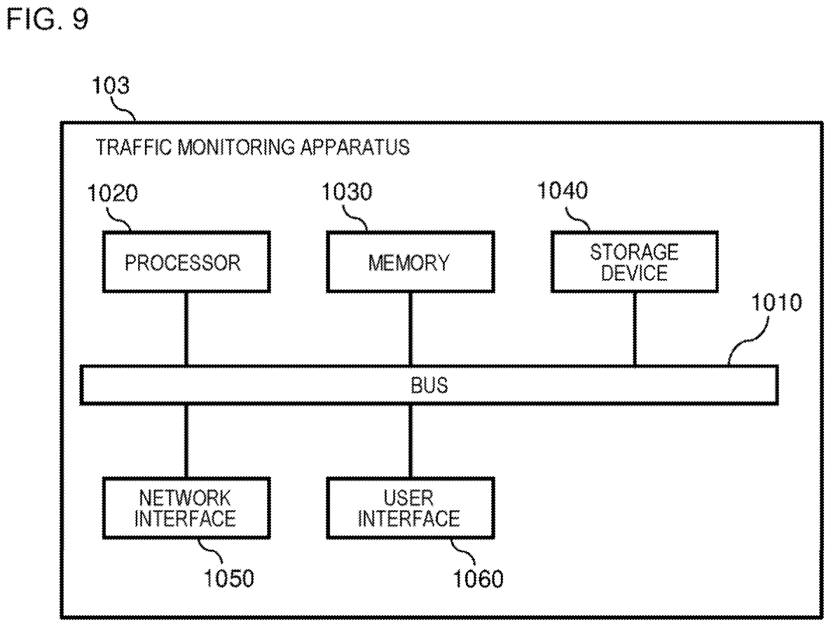

As illustrated in FIG. 9, the traffic monitoring apparatus 103 physically includes a bus 1010, a processor 1020, a memory 1030, a storage device 1040, a network interface 1050, and a user interface 1060.

The bus 1010 is a data transmission path through which the processor 1020, the memory 1030, the storage device 1040, the network interface 1050, and the user interface 1060 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like.

The storage device 1040 achieves a storage unit (the first learning model storage unit 112a_3, the congestion pattern storage unit 112b_1, and the criterion storage unit 114_a2) of the traffic monitoring apparatus 102, and a function of storing information.

Moreover, the storage device 1040 stores a program module for achieving each functional unit (the front position detection unit 112 (the position history generation unit 112a (the vehicle position acquisition unit 112a_1 and the history generation unit 112a_2) and the front detection unit 112b (the congestion detection unit 112b_2 and the front determination unit 112b_3)), and the output unit 114 (the feature detection unit 114_a1, the decision unit 114_a3, the decision result output unit 114_a4)) of the traffic monitoring apparatus 102. The processor 1020 reads each of the program modules onto the memory 1030, executes the read program module, and thereby achieves each function being associated with the program module.

The network interface 1050 is an interface for connecting the traffic monitoring apparatus 102 to a network configured in a wired way, in a wireless way, or in a combinational way thereof. The traffic monitoring apparatus 102 according to the present example embodiment is connected to the network through the network interface 1050, and thereby communicates with sensing apparatus 102 and the like. Moreover, the traffic monitoring apparatus 102 according to the present example embodiment is connected to the network through the network interface 1050, and thereby communicates with the driving control apparatus mounted on the vehicle 101, a previously determined information processing apparatus, and the like.

The user interface 1070 is an interface to which information is input from a user and an interface that presents information to a user, and includes, for example, a mouse, a keyboard, a touch sensor, or the like as the input unit 105, and a liquid crystal display or the like as a display unit.

In this way, each physical component cooperatively executes a software program, and, thereby, a function of the traffic monitoring apparatus 102 can be achieved. Thus, the present invention may be achieved as also referred to as “softwarepsoftwareprogramgram”.), or may be achieved as a non-transitory storage medium in which the program is recorded.

<Traffic Monitoring Processing According to the Present Example Embodiment>

From now on, traffic monitoring processing according to one example embodiment of the present invention is described with reference to the drawings.

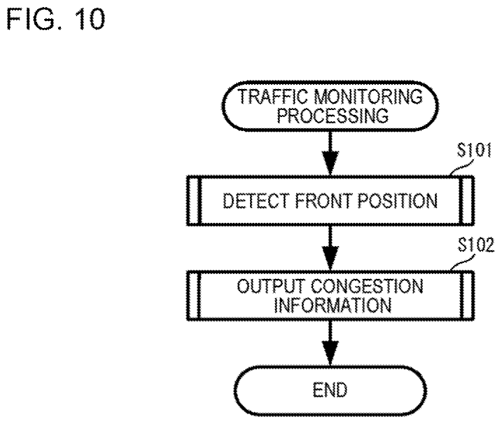

FIG. 10 is a flowchart illustrating one example of the traffic monitoring processing according to the present example embodiment.

The traffic monitoring processing is processing for monitoring traffic on the road R, and is performed by referring to position information repeatedly acquired from the sensing apparatus 102, for example, at a regular time interval. For example, when a start instruction of a user from the input unit 103 is accepted, the traffic monitoring processing is repeatedly executed until an instruction for ending is accepted.

FIG. 10 is referred to.

The front position detection unit 112 acquires, from the sensing apparatus 102, a vehicle position on the road R. Then, the front position detection unit 112 detects, based on the acquired vehicle position, a front position of congestion on the road R (step S101).

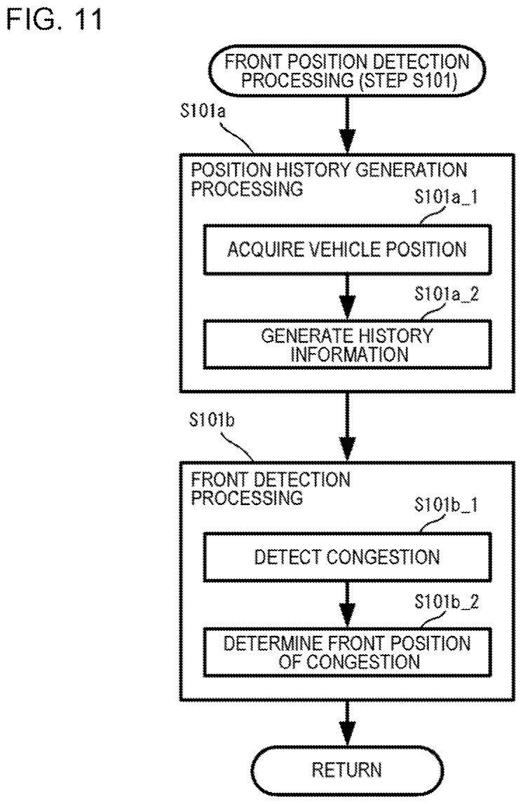

FIG. 11 is a flowchart illustrating one example of front position detection processing (step S101). As illustrated in FIG. 11, the position history generation unit 112a performs position history generation processing (step S101a).

In the position history generation processing (step S101a), the position history generation unit 112a acquires, from the sensing apparatus 102, position information of the vehicle 101 on the road R. Then, the position history generation unit 112a generates, based on the vehicle position included in the position information, the history information 105 indicating the history DH of a vehicle position of the vehicle 101 on the road R.

Specifically, in step S101a, the vehicle position acquisition unit 112a_1 acquires, based on the position information on the road R acquired from the sensing apparatus 102, a vehicle position of the vehicle 101 passing on the road R (step S101a_1).

The history generation unit 112a_2 generates, based on the vehicle position acquired in step S101a_1, the history information 105 including a change over time in the vehicle position from past to present, i.e., the history DH of a vehicle position (step S101a_2).

Herein, a vehicle position can be acquired in a relatively short period in step S101a_1. Thus, the history generation unit 107 may generate the history information 105, based on the vehicle position acquired in step S101 at a previously determined time being longer than an acquisition period of a vehicle position.

Next, the front detection unit 112b performs front detection processing (step S101b).

In the front detection processing, the front detection unit 112b detects a front position of congestion on the road R, based on the history information 105 generated in step S101a_2.

In step S101b, the congestion detection unit 112b_2 detects congestion on the road R, based on the history information 105 generated in step S101a_2, and the congestion pattern information 121 in the congestion pattern storage unit 112b_1 (step S101b_1).

Specifically, for example, the congestion detection unit 112b_2 collates (e.g., pattern matching) the history DH of a vehicle position included in the history information 105 with a congestion pattern indicated by the congestion pattern information 121, and thereby derives a similarity degree between therebetween.

Then, when the similarity degree is greater than a previously determined threshold value, the congestion detection unit 112b_2 detects congestion on the road R, and outputs detection information indicative thereof to the front determination unit 112b_2. When the similarity degree is equal to or less than a previously determined threshold value, the congestion detection unit 112b_2 does not detect congestion on the road R, and notifies the front determination unit 112b_2 of non-detection information indicative thereof.

Note that, when no congestion is detected, the congestion detection unit 112b_2 may end the traffic monitoring processing.

Note that, a congestion pattern is not limited to that exemplified in the present example embodiment, and various patterns can be assumed according to, for example, appropriateness of congestion. Accordingly, the congestion detection unit 112b_2 may detect congestion, based on a learning model, with a change over time in a vehicle position as an input. For the learning model in this case, a learned learning model that has performed machine-learning for generating, with, as an input, a change over time in a vehicle position, information (detection information and non-detection information) indicating whether congestion has occurred according to a similarity degree between the change and the congestion pattern may be adopted. The learning may be supervised learning, and the learning model may be previously stored in a storage unit instead of the congestion pattern storage unit 112b_1.

Moreover, the congestion detection unit 112b_2 may detect an abnormal event, based on whether a feature of a congestion pattern is included in a change over time in a vehicle position.

When detection information is acquired from the congestion detection unit 112b_2 in response to detection of congestion in step S101b_1, the front determination unit 112b_3 determines a front position of the congestion (step S101b_2).

Specifically, the front determination unit 112b_3 determines a front position of congestion at each time, based on the history DH of a vehicle position, and the congestion pattern information 121 stored in the congestion pattern storage unit 112b_1. Thereby, the front determination unit 112b_3 can determine a change over time in movement of the front position of the congestion, i.e., a history of the movement of the front position of the congestion.

More specifically, in determination of a history of movement of a front position of congestion, for example, the front determination unit 112b_3 detects a region that matches the congestion pattern information 121 in the history DH of a vehicle position. For example, the front determination unit 112b_3 determines, as a front position of congestion at each time, a current position of the vehicle 101 located most forward (a right side in the history DH in FIGS. 1 to 4) in the traveling direction at each time within the detected region. Thereby, a history of the movement of the front position of the congestion including a time and a front position on the road R at the time can be acquired.

Thereby, the front determination unit 112b_3 ends step S101, and a return is made to the traffic monitoring processing illustrated in FIG. 10.

FIG. 10 is referred to again.

The output unit 114 decides whether the movement of the front position of the congestion detected in the front position detection processing (step S101) satisfies a previously determined criterion, and outputs congestion information according to a result of the decision (step S102).

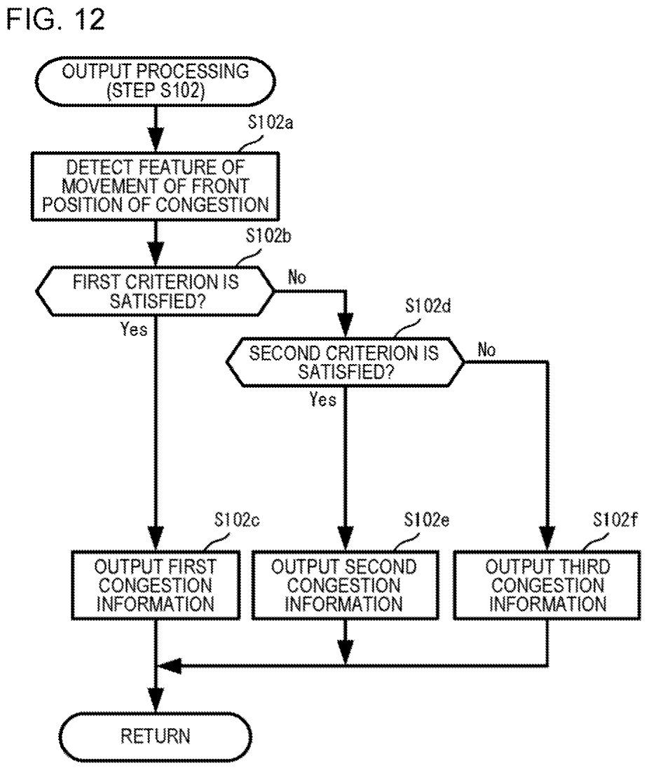

FIG. 12 is a flowchart illustrating one example of output processing (step S102).

As illustrated in FIG. 12, the feature detection unit 114_a1 detects, based on the history DH of a vehicle position where congestion is detected in step S101b_1, a feature of movement of the front position of the congestion (step S102a).

More specifically, the feature detection unit 114_a1 derives, based on a history of movement of a front position determined in step S101b_2, a moving direction of the front position and a moving velocity thereof (e.g., Km/Hour), and thereby detects a feature of movement of the front position.

The decision unit 114b_3 decides whether the feature of the movement of the front position detected in step S102a satisfies the first criterion (step S102b).

Specifically, the decision unit 114b_3 acquires the first criterion included in the criterion information 124 stored in the criterion storage unit 114_a2. The decision unit 114b_3 decides, based on the acquired first criterion, and the feature of the movement of the front position detected in step S102a, whether the feature of the movement satisfies the first criterion.

For example, as illustrated in FIG. 8, it is assumed that the first criterion includes a moving direction being a direction opposite to a traveling direction, and a moving velocity being faster than the first threshold value.

In this case, the decision unit 114b_3 decides that the first criterion is satisfied, when the moving direction included in the feature of the movement of the front position is an opposite direction to the traveling direction of the road R, and a moving velocity included in the feature of the movement of the front position is faster than the first threshold value.

Moreover, for example, the decision unit 114b_3 decides that the first criterion is not satisfied, when the moving direction included in the feature of the movement of the front position is not an opposite direction to the traveling direction of the road R but is the traveling direction, or when no movement is made. The decision unit 114b_3 also decides that the first criterion is not satisfied, when a moving velocity included in the feature of the movement of the front position is the same as the first threshold value or is slower than the first threshold value.

When it is decided that the first criterion is satisfied (step S102b; Yes), the decision result output unit 114b_4 outputs the first congestion information (step S102c).

When it is decided that the first criterion is not satisfied (step S102b; No), the decision unit 114b_3 decides whether the feature of the movement of the front position detected in step S102a satisfies the second criterion (step S102d).

Specifically, the decision unit 114b_3 acquires the second criterion included in the criterion information 124 stored in the criterion storage unit 114_a2. The decision unit 114b_3 decides, based on the acquired second standard, and the feature of the movement of the front position detected in step S102a, whether the feature of the movement satisfies the second standard.

For example, as illustrated in FIG. 8, it is assumed that the second criterion includes a moving direction being a traveling direction, and a moving velocity being slower than the second threshold value.

In this case, the decision unit 114b_3 decides that the second criterion is satisfied, when a moving direction included in the feature of the movement of the front position is the traveling direction of the road R, and a moving velocity included in the feature of the movement of the front position is slower than the second threshold value.

Moreover, for example, the decision unit 114b_3 decides that the second criterion is not satisfied, when the moving direction included in the feature of the movement of the front position is not the traveling direction of the road R but an opposite direction to the traveling direction, or when no movement is made. The decision unit 114b_3 also decides that the second criterion is not satisfied, when a moving velocity included in the feature of the movement of the front position is the same as the second threshold value or is faster than the second threshold value.

When it is decided that the second criterion is satisfied (step S102d; Yes), the decision result output unit 11411_4 outputs the second congestion information (step S102e).

When it is decided that the second criterion is not satisfied (step S102d; No), the decision result output unit 114b_4 outputs the third congestion information (step S102f).

Note that, the decision unit 114b_3 may display a decision result on, for example, a display unit or the like included in the traffic monitoring apparatus 103. Then, a user may operate, for example, the traffic monitoring apparatus 103, acquire, from a surveillance camera or the like installed on the road R, a current video of a place where it is decided that congestion has occurred, and refer to the acquired current video.

Thereby, since whether a result of decision is correct can be confirmed, it becomes possible to provide more accurate congestion information.

Moreover, when it is decided that congestion of an unknown cause has occurred, a user may operate, for example, the traffic monitoring apparatus 103, confirm a video, and cause to include, for example, more detailed information of an accident or the like in the third congestion information.

Thereby, since more detailed congestion information can be output, it becomes possible to provide more accurate and detailed congestion information.

According to one example embodiment of the present invention, when a front position of congestion on the road R is detected, and movement of the detected front position satisfies a previously determined criterion, congestion information according to the criterion is output. Thereby, a traffic situation of the road R at congestion occurrence can be recognized based on the movement of the front position of the congestion. Therefore, it becomes possible to accurately recognize a traffic situation of a road.

In the present example embodiment, a criterion includes a first criterion, and the first criterion includes a fact that a moving direction of a front position is a direction opposite to a traveling direction of the road R. Then, when movement of a detected front position satisfies the first criterion, output according to the first criterion is performed. Generally, in congestion resulting from the reverse driving vehicle 106, a moving direction of a front position often becomes a direction opposite to a traveling direction of the road R. Thus, the reverse driving vehicle 106 can be sensed by performing output based on whether the moving direction of the front position is a direction opposite to the traveling direction of the road R. Moreover, a cause of congestion can be estimated substantially in real time. Therefore, it becomes possible to recognize a traffic situation of a road more accurately.

In the present example embodiment, the first criterion further includes a fact that a moving velocity of a front position is faster than a previously determined first threshold value. Thereby, the reverse driving vehicle 106 can be sensed more accurately, and also a cause of congestion can be estimated more accurately substantially in real time. Therefore, it becomes possible to recognize a traffic situation of a road still more accurately.

In the present example embodiment, a criterion includes a second criterion. The second criterion includes a fact that a moving direction of a front position is a traveling direction of the road R. Then, when movement of a detected front position satisfies the second criterion, output according to the second criterion is performed. Generally, in congestion resulting from an accident, a front position often does not move at a constant position until accident handling is completed, and congestion in which a front position moves in a traveling direction is often caused by a low-velocity vehicle.

Thus, a low-velocity vehicle can be sensed by performing output based on whether the moving direction of the front position is a traveling direction of the road R. Moreover, a cause of congestion can also be estimated substantially in real time. Therefore, it becomes possible to recognize a traffic situation of a road more accurately.

In the present example embodiment, the second criterion further includes a fact that a moving velocity of a front position is slower than a previously determined second threshold value. Thereby, a low-velocity vehicle can be sensed more accurately, and a cause of congestion can also be more accurately estimated substantially in real time. Therefore, it becomes possible to recognize a traffic situation of a road still more accurately.

In the present example embodiment, history information indicating a history of a vehicle position on the road R is generated, and a front position of congestion on the road R is detected based on the history information. A vehicle position on the road R can be acquired in real time from the road R in a wide area, and a traffic situation of the road R can be recognized in an overlooking way. Therefore, it becomes possible to recognize a traffic situation of a road over a wide area in real time in an overlooking way.

In the present example embodiment, the history information 105 is generated based on a vehicle position, and the vehicle position is acquired based on optical fiber sensing utilizing an optical fiber laid on the road R. There are many roads, such as an expressway, on which an optical fiber for communication is laid, and a vehicle position can be acquired by utilizing the optical fiber that has been already laid.

Moreover, by utilizing an optical fiber sensing technique, a vehicle position can be acquired from the road R in a wide area in real time, and a traffic situation of the road R can be recognized in an overlooking way.

Therefore, it becomes possible to recognize a traffic situation of a road over a wide area in real time in an overlooking way, while suppressing generation of additional cost.

The present invention is not limited to the one example embodiment described above. An example embodiment may be modified, for example, as follows.

### Modified Example 1

In the example embodiment, an example where a vehicle position is acquired from a sensing apparatus 102 without distinguishing between lanes TL and OL for traveling in the same direction on a road R, and a front position of congestion is detected has been described. However, a traffic monitoring apparatus 103 may acquire a vehicle position of a vehicle 101 for each of the lanes TL and OL from the sensing apparatus 102.

For example, pavement of the road R may differ for each of the lanes TL and OL, and, thereby, observation information with which the lanes TL and OL where the vehicle R passes are identifiable may be able to be acquired. In such a case, a front position detection unit 112 may acquire a vehicle position of the vehicle 101 for each of the lanes TL and OL from the sensing apparatus 102, and detect a front position of congestion on each lane of the road R.

Moreover, when movement of the detected front position in each lane satisfies a previously determined criterion, an output unit 114 may output congestion information according to the criterion. The congestion information may include occurrence of congestion for each lane and a cause thereof.

Generally, reverse driving is often accidentally made on the road R at an interchange where the road R intersects complicatedly, or during merging from a parking area to the road R. Thus, for example, when the road R is left-hand traffic, and a right-hand lane in a traveling direction is set as an overtaking lane OL, a reverse driving vehicle 106 often drives reverse on the overtaking lane OL.

By detecting a detection position of congestion for each lane, congestion resulting from the reverse driving vehicle 106 in a lane such as the overtaking lane OL where the reverse driving vehicle 106 is apt to occur can be particularly monitored. Thereby, congestion resulting from the reverse driving vehicle 106 can be more reliably detected, congestion information can be provided, and, therefore, it becomes possible to improve safety of traffic on the road R.

### Modified Example 2

For example, a first criterion may include a threshold value TTH determined with regard to a time from detection of congestion to start of movement of a front position.

As described in the example embodiment, in congestion resulting from a reverse driving vehicle 106, a time from detection of congestion to start of movement of a front position is short, unlike congestion resulting from an accident or the like.

Thus, by further adding, to a condition, a fact that a time from detection of congestion to start of movement of a front position is shorter than the threshold value TTH in a history DH, and performing decision, congestion resulting from the reverse driving vehicle 106 and congestion resulting from an accident or the like can be distinguished more accurately. Therefore, it becomes possible to estimate a cause of congestion more accurately.

While the example embodiment and the modified examples according to the present invention have been described above, the present invention is not limited thereto. For example, the present invention also includes a form in which part or all of the example embodiment and the modified examples described so far are appropriately combined, and a form in which the former form is appropriately modified.

One means or all means according to the example embodiment described above can also be described as, but are not limited to, the following supplementary notes.

1. A traffic monitoring apparatus including:
a front position detection means for detecting a front position of congestion on a road; and
an output means for outputting, when movement of the detected front position satisfies a previously determined criterion, congestion information according to the criterion.

2. The traffic monitoring apparatus according to supplementary note 1, wherein
the criterion includes a first criterion including a fact that a moving direction of the front position is a direction opposite to a traveling direction of the road, and,
when movement of the detected front position satisfies the first criterion, the output means performs output according to the first criterion.

3. The traffic monitoring apparatus according to supplementary note 2, wherein
the first criterion further includes a fact that a moving velocity of the front position is faster than a previously determined first threshold value.

4. The traffic monitoring apparatus according to supplementary note 1, wherein
the criterion includes a second criterion including a fact that a moving direction of the front position is a traveling direction of the road, and,
when movement of the detected front position satisfies the second criterion, the output means performs output according to the second criterion.

5. The traffic monitoring apparatus according to supplementary note 4, wherein
the second criterion further includes a fact that a moving velocity of the front position is slower than a previously determined second threshold value.

6. The traffic monitoring apparatus according to any one of supplementary notes 1 to 5, wherein
the front position detection means includes
a position history generation means for generating history information indicating a history of a vehicle position on the road, and
a front detection means for detecting, based on the history information, a front position of congestion on the road.

7. The traffic monitoring apparatus according to supplementary note 6, wherein
the position history generation means includes
a vehicle position acquisition means for acquiring a vehicle position on the road acquired based on optical fiber sensing utilizing an optical fiber laid on the road, and
a history generation means for generating the history information, based on the vehicle position.

8. The traffic monitoring apparatus according to any one of supplementary notes 1 to 7, wherein,
when the road includes a plurality of lanes for traveling in a same direction, the front position detection means detects a front position of congestion in each lane of the road.

9. A traffic monitoring system including:
the traffic monitoring apparatus according to any one of supplementary notes 1 to 8;
an optical fiber being laid on the road, and having one end subjected to termination processing that suppresses reflection of an optical signal; and
a sensing apparatus that inputs an optical signal to the optical fiber, and also observes a change amount of optical interference intensity being intensity of light in which beams of backscattered light generated due to the input of the optical signal interfere with each other, wherein
the front position detection means acquires a vehicle position on the road acquired based on a change amount of the optical interference intensity observed by the sensing apparatus, and detects a front position of congestion on the road, based on the vehicle position.

10. A traffic monitoring method including,
by a computer:
detecting a front position of congestion on a road; and
performing, when movement of the detected front position satisfies a previously determined criterion, output according to the criterion.

11. A program for causing a computer to function as the traffic monitoring apparatus according to any one of supplementary notes 1 to 8.

This application is based upon and claims the benefit of priority from Japanese patent application No. 2021-034187, filed on Mar. 4, 2021, the disclosure of which is incorporated herein in its entirety by reference.

### REFERENCE SIGNS LIST

100 Traffic monitoring system
101 Vehicle
OF Optical fiber
102 Sensing apparatus
103 Traffic monitoring apparatus
105, 105a_1, 105a_2, 105b_1, 105b_2 History information
106 Reverse driving vehicle
110 Input unit
112 Front position detection unit
112a Position history generation unit
112a_1 Vehicle position acquisition unit
112a_2 History generation unit
112a_3 First learning model storage unit
112b Front detection unit
112b_1 Congestion pattern storage unit
112b_2 Congestion detection unit
112b_3 Front determination unit
114 Output unit
114_a1 Feature detection unit
114_a2 Criterion storage unit
114_a3 Decision unit
114_a4 Decision result output unit
121 Congestion pattern information
124 Criterion information

What is claimed is:

1. A traffic monitoring apparatus comprising:
at least one memory configured to store instructions; and
at least one processor configured to execute the instructions to perform operations comprising:
detecting a front position of congestion on a road; and
outputting, when movement of the detected front position satisfies a previously determined criterion, congestion information according to the criterion.

2. The traffic monitoring apparatus according to claim 1, wherein
the criterion includes a first criterion including a fact that a moving direction of the front position is a direction opposite to a traveling direction of the road, and,
when movement of the detected front position satisfies the first criterion, outputting the congestion information according to the first criterion.

3. The traffic monitoring apparatus according to claim 2, wherein
the first criterion further includes a fact that a moving velocity of the front position is faster than a previously determined first threshold value.

4. The traffic monitoring apparatus according to claim 1, wherein
the criterion includes a second criterion including a fact that a moving direction of the front position is a traveling direction of the road, and,
when movement of the detected front position satisfies the second criterion, outputting the congestion information according to the second criterion.

5. The traffic monitoring apparatus according to claim 4, wherein
the second criterion further includes a fact that a moving velocity of the front position is slower than a previously determined second threshold value.

6. The traffic monitoring apparatus according to claim 1, wherein
detecting the front position includes
generating history information indicating a history of a vehicle position on the road, and
detecting, based on the history information, a front position of congestion on the road.

7. The traffic monitoring apparatus according to claim 1, wherein,
when the road includes a plurality of lanes for traveling in a same direction, detecting the front position includes a front position of congestion in each lane of the road.

8. A traffic monitoring system comprising:
the traffic monitoring apparatus according to claim 1;
an optical fiber being laid on the road, and having one end subjected to termination processing that suppresses reflection of an optical signal; and
a sensing apparatus that inputs an optical signal to the optical fiber, and also observes a change amount of optical interference intensity being intensity of light in which beams of backscattered light generated due to the input of the optical signal interfere with each other, wherein
detecting the front position acquiring a vehicle position on the road acquired based on a change amount of the optical interference intensity observed by the sensing apparatus, and detects a front position of congestion on the road, based on the vehicle position.

9. A traffic monitoring method comprising,
by at least one computer:
detecting a front position of congestion on a road; and
performing, when movement of the detected front position satisfies a previously determined criterion, output according to the criterion.

10. A non-transitory storage medium storing a program for causing at least one computer to execute:
detecting a front position of congestion on a road; and
performing, when movement of the detected front position satisfies a previously determined criterion, output according to the criterion.
